(19) United States
(12) Patent Application Publication
(10) Pub. No.: US 2008/0174636 A1
(43) Pub. Date: Jul. 24, 2008

(54) INKJET PRINTER AND INKJET PRINTER HEAD-CHIP ASSEMBLY THEREOF

(75) Inventors: Jung-wook KIM, Yongin-si (KR); Young-su Lee, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/866,119

(22) Filed: Oct. 2, 2007

(30) Foreign Application Priority Data
Jan. 18, 2007 (KR) 2007-5760

(51) Int. Cl. B41J 2/01

(52) U.S. Cl. 347/47

(57) ABSTRACT

An inkjet printer includes an ink tank, a head chip comprising a nozzle and a signal pad, a base plate provided between the ink tank and the head chip and having a first ink flow path through which ink of the ink tank is supplied to the head chip, a head chip supporting member provided between the base plate and the head chip, comprising a second ink flow path which makes the nozzle communicate with the first ink flow path, and detachably combined to the base plate together with the head chip, and a controlling part which controls the head chip.

### CROSS-REFERENCE TO RELATED APPLICATIONS

This application claims priority from Korean Patent Application No. 10-2007-0005760, filed on Jan. 18, 2007 in the Korean Intellectual Property Office, the disclosure of which is incorporated herein by reference.

### BACKGROUND OF THE INVENTION

1. Field of the Invention

Apparatuses consistent with the present general inventive concept relate to an inkjet printer and inkjet printer head-chip assembly thereof, and more particularly to an inkjet printer and inkjet printer head-chip assembly thereof with an improved assembling performance.

2. Description of the Related Art

An inkjet printer head is a device which ejects a small printing ink droplet onto a required position of a printing medium to thereby print an image of a predetermined color. Such an inkjet printer head is classified as a shuttle type head when the head moves across a width of the printing medium to print one line. Note that the term “width” as used in this disclosure is independent of the size of the printing medium. The term “width” as used in this disclosure, when referring to the printing medium, indicates the direction transverse to the printing medium transferring direction even in the case where the printing medium has such a size that its length in the transferring direction is less than its length transverse to the transferring direction. The inkjet printer head is classified as an array type head where head chips are disposed across the whole width of the printing medium to print one line at once.

As illustrated in FIG. 1 and FIG. 2, a conventional inkjet printer 1 has head chips 10, a flexible printed circuit (FPC) 20, a base plate 30, an intermediate plate 40, an upper plate 50, a SUS plate 60, a negative pressure generating device 70, and an ink tank 80. The ink tank is supported by a frame 3.

Ink of the ink tank 80 passes through the negative pressure generating device 70 and an ink path formed within each plate 30, 40, 50, to be supplied to a nozzle (not shown) formed at each head chip 10. In this case, in a non-printing state, the negative pressure generating device 70 applies a negative pressure to the ink so that the ink does not seep through the nozzle (not shown). A gasket 5 is interposed between the SUS plate 60 and the negative pressure generating device 70 to prevent the ink from leaking.

The head chips 10 are disposed along the length of the base plate 30 so that the head chips can simultaneously print one line on the printing medium. Accordingly, the inkjet printer 1 has the array type head. A sealant is applied to a head chip receiving part 31 of the base plate 30 to attach the head chip 10 thereon. In the head chip 10, a heater (not shown) is disposed at each ink chamber where the nozzle is formed. The heater (not shown) receives heater driving power from a controlling part (not shown) to heat the ink chamber. Accordingly, heat-expanded ink is ejected through the nozzle to the outside, thus accomplishing printing.

The FPC 20 connects a signal pad 13 of the head chip 10, which receives a control signal, with the controlling part (not shown). A lead line 23 of the FPC 20 is connected to the signal pad 13 of the head chip 10 by wire bonding. After the wire bonding, a packaging operation is performed, where an encapsulant is applied to an upper side of the flexible printed circuit 20 and an underfiller is applied to fill a lower side of the FPC 20 so that a combining part between the lead line 23 and the signal pad 13 can be protected.

However, according to the conventional inkjet printer head 1, since a plurality of head chips 10 are attached together to the base plate 30 with a sealant, it is not easy to replace a defective head chip 10 if only one of the plurality of head chips 10 is defective.

Moreover, if a defect is generated during the wire bonding operation or the packing operation, the whole set of head chips 10 combined with the base plate 30 may be unusable, thus lowering yield.

### SUMMARY OF THE INVENTION

The present general inventive concept provides an inkjet printer and an inkjet printer head-chip assembly thereof where a yield can be improved.

The present general inventive concept also provides an inkjet printer and an inkjet printer head-chip assembly thereof where an assembling performance is improved.

Additional aspects and utilities of the present general inventive concept will be set forth in part in the description which follows and, in part, will be obvious from the description, or may be learned by practice of the present general inventive concept.

The foregoing and/or other aspects and utilities of the present general inventive concept can be achieved by providing an inkjet printer comprising an ink tank, a head chip comprising a nozzle and a signal pad, a base plate provided between the ink tank and the head chip, the base plate having a first ink flow path through which ink of the ink tank is supplied to the head chip, a head chip supporting member provided between the base plate and the head chip, the head chip supporting member comprising a second ink flow path which allows the nozzle to communicate with the first ink flow path, and the head chip supporting member being detachably combined to the base plate together with the head chip, and a controlling part which controls the head chip.

The head chip and the head chip supporting member may be plurally provided respectively, and the first ink flow path and the second ink flow path are plurally provided respectively so that the ink of the ink tank can be supplied to each head chip.

The inkjet printer may further comprise a flexible printed circuit which combines the signal pad of the head chip with the controlling part to transmit a control signal of the controlling part to the head chip, wherein the head chip supporting member has a surface-processed edge at a side part where the signal pad is disposed so that the flexible printed circuit is bent to be attached to the edge.

The edge of the head chip supporting member may be surface-processed to be an inclined surface.

The edge of the head chip supporting member may be surface-processed to be a curved surface.

The head chip supporting member may have a sealant receiving groove which is formed at the edge.

The sealant receiving groove may be plurally provided.

The head chip supporting member may further comprise blocking parts which are provided at opposite end parts of the sealant receiving groove to prevent overflow of a sealant therefrom.

The head chip supporting member and the base plate may be combined therebetween by a separable combining means.

The foregoing and/or other aspects and utilities of the present general inventive concept may also be achieved by providing an inkjet printer head-chip assembly comprising a base plate comprising a first ink inflow opening, a first ink outflow opening, and a first ink flow path which allows the first ink inflow opening to communicate with the first ink outflow opening, a head chip comprising a nozzle and a signal pad which receives a signal, and a head chip supporting member comprising a head chip combining part to which the head chip is combined, a second ink inflow opening which communicates with the first ink outflow opening, a second ink outflow opening which is provided at the head chip combining part to communicate with the nozzle, and a second ink flow path which allows the second ink inflow opening to communicate with the second ink outflow opening, and provided to be detachably attached to the base plate together with the integrally formed head chip.

The same plural number of the head chips and the head chip supporting members may be provided, and the base plate may further comprise a chip module receiving part, to which the head chip supporting member is received, along an extending direction of the base plate.

The inkjet printer head-chip assembly may further comprise a flexible printed circuit which is combined to the signal pad of the head chip to transmit an outer signal to the head chip, and the head chip supporting member may have a surface-processed edge at a side part where the signal pad is disposed so that the flexible printed circuit is bent to be attached to the edge.

The edge of the head chip supporting member may be surface-processed to be an inclined surface.

The edge of the head chip supporting member may be surface-processed to be a curved surface.

The head chip supporting member may have a sealant receiving groove which is formed at the surface-processed edge.

The sealant receiving groove may be plurally provided.

The inkjet printer head-chip assembly may further comprise a blocking part which is provided at each end part of the sealant receiving groove to prevent overflow of a sealant therefrom.

The head chip supporting member and the base plate may be combined therebetween by a separable combining means.

The foregoing and/or other aspects and utilities of the present general inventive concept may also be achieved by providing a method of manufacturing an image forming apparatus, comprising attaching a plurality flexible printed circuits to corresponding head chips mounted on corresponding head chip supporting members, and after the attaching the plurality of flexible printed circuits to corresponding head chips, mounting the plurality of head chip supporting members to a base plate.

The foregoing and/or other aspects and utilities of the present general inventive concept may also be achieved by providing a method of assembling an image forming apparatus, comprising attaching a plurality of head chips to a plurality of corresponding head chip mounting members, attaching a flexible printed circuit to each of the head chips, including wire bonding leads to signal pads of the head chips, at least partially encapsulating the leads, and mounting the plurality of head chip mounting members with attached corresponding head chips to a base plate.

### BRIEF DESCRIPTION OF THE DRAWINGS

The above and/or other aspects and utilities of the present general inventive concept will become apparent and more readily appreciated from the following description of the exemplary embodiments, taken in conjunction with the accompanying drawings, in which:

FIG. 1 is a sectional view of a conventional inkjet printer head;

FIG. 2 is a plan view of a part of the inkjet printer head in FIG. 1;

FIG. 3 is an perspective view of an inkjet printer head according to an exemplary embodiment;

FIG. 4 is an perspective view of a base plate of the inkjet printer in FIG. 3;

FIG. 5A and FIG. 5B are a perspective view and a side view of a head-chip supporting member of the inkjet printer in FIG. 3 respectively;

FIG. 5C is a perspective view of a chip module where a head chip and a flexible printed circuit are assembled in the head-chip supporting member in FIG. 5A;

FIG. 6A and FIG. 6B are perspective views of the head-chip supporting member and the chip module having the head-chip supporting member according to another exemplary embodiment, respectively;

FIG. 7A and FIG. 7B are perspective views of the head-chip supporting member and the chip module having the head-chip supporting member according to another exemplary embodiment, respectively;

FIG. 8 is a sectional view for explaining an exemplary manufacturing method of the chip module in FIG. 5C;

FIG. 9A is a exploded sectional view explaining an exemplary manufacturing method of the chip module in FIGS. 5A-5C;

FIG. 9B is an exploded sectional view explaining an exemplary manufacturing method of the chip module in FIG. 6B;

FIG. 10 is a sectional view explaining another manufacturing method of the chip module in FIG. 6B; and

FIG. 11 is a sectional view of a part of the inkjet printer head in FIG. 3.

FIGS. 12A and 12B illustrate example methods of manufacturing the chip module.

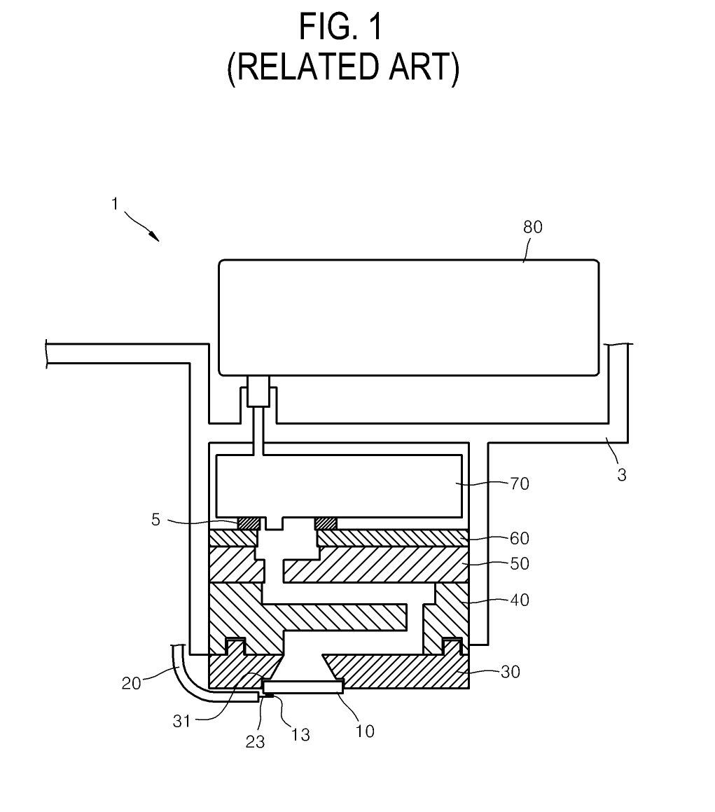

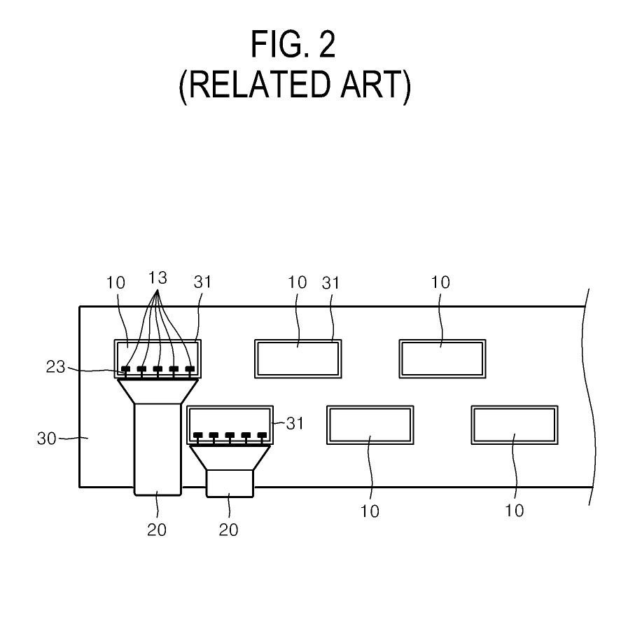

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

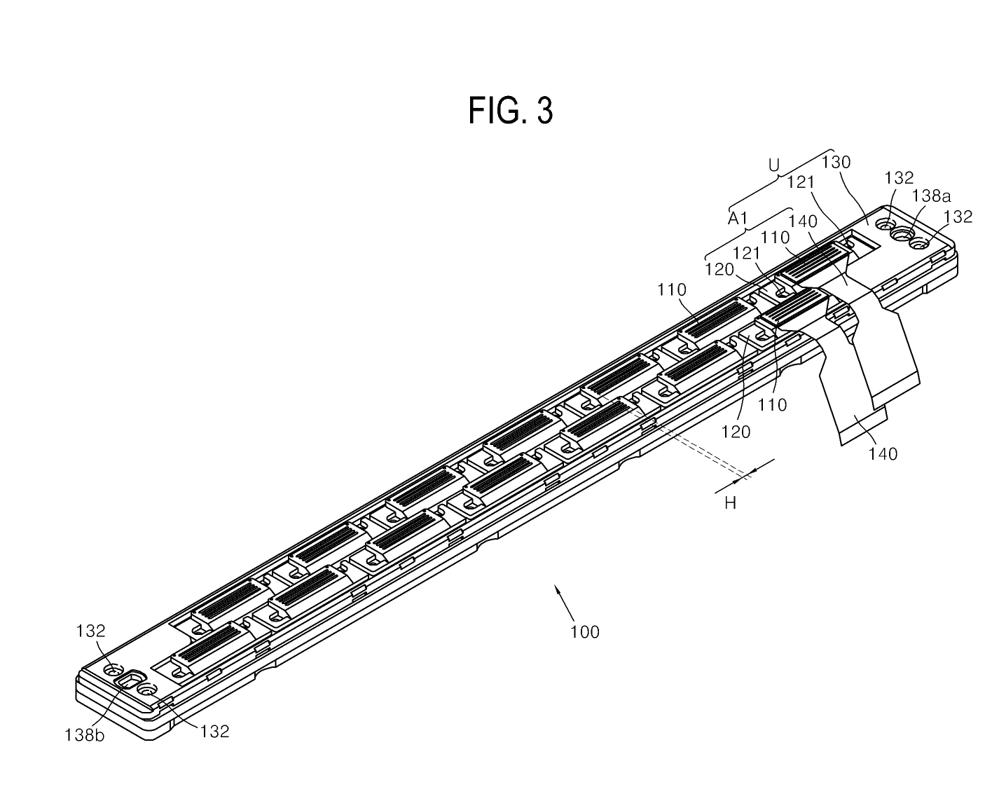

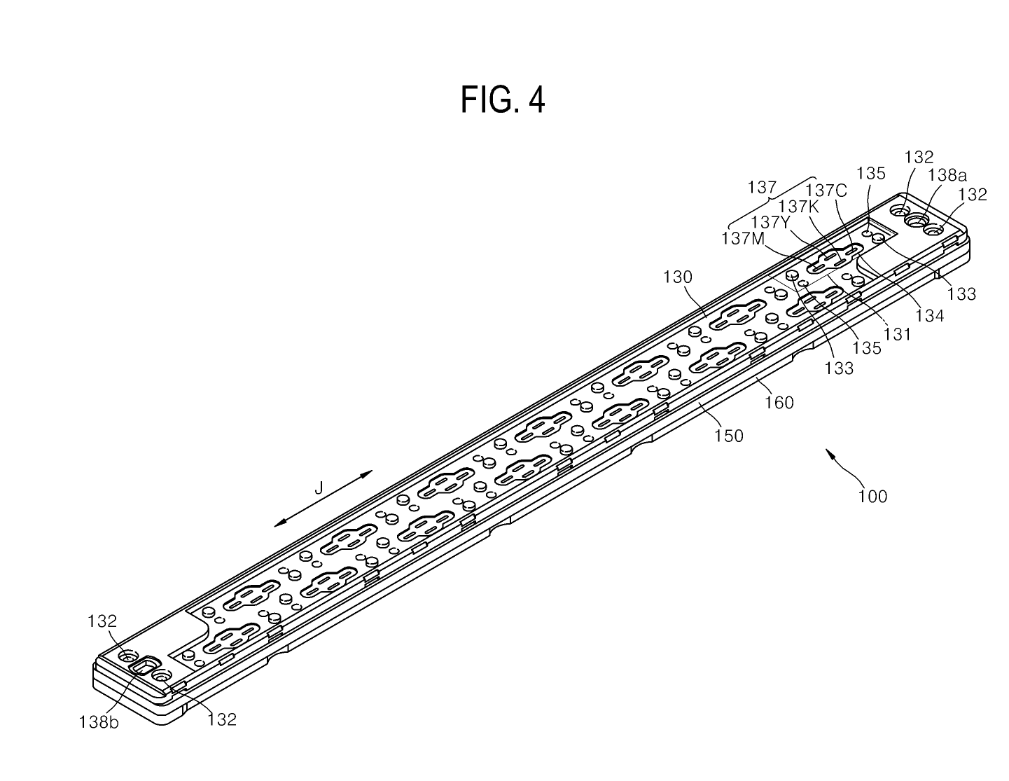

As illustrated in FIGS. 3 and 4, an inkjet printer 100 according to an exemplary embodiment includes an inkjet printer head-chip assembly U which has a chip module A1 and a base plate 130, an intermediate plate 150, and an upper plate 160.

The base plate 130, the intermediate plate 150 and the upper plate 160 are combined together by couplers and plate coupling holes 132 which are formed at left and right end parts of the base plate 130.

An ink path is formed in each of the intermediate plate 150 and the upper plate 160 to transfer ink, which is supplied from an ink tank (not shown), to the base plate 130. The intermediate plate 150 and the upper plate 160 may be integrally provided if necessary. As the intermediate plate 150 and the upper plate 160 may be the same as or similar to conventional ones such that those skilled in the art can easily adapt for use with the present inventive concept, their detail descriptions are omitted.

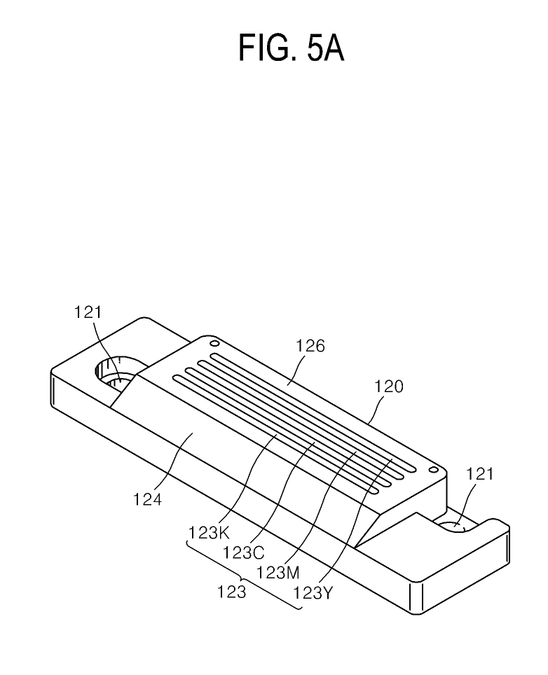

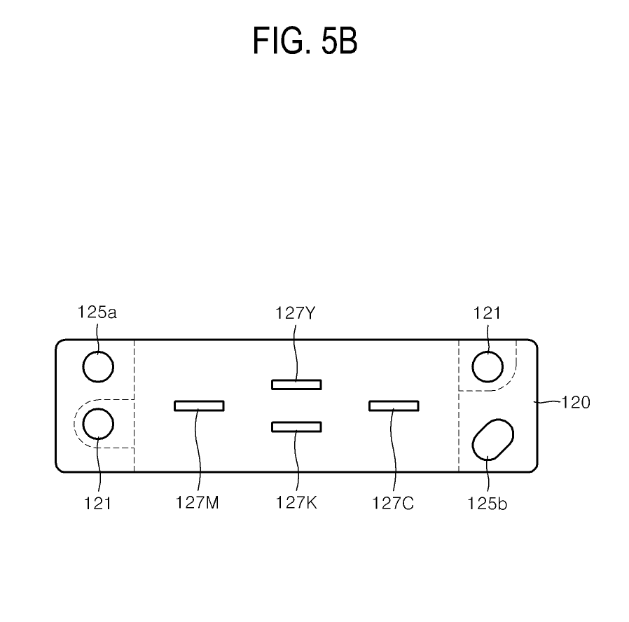

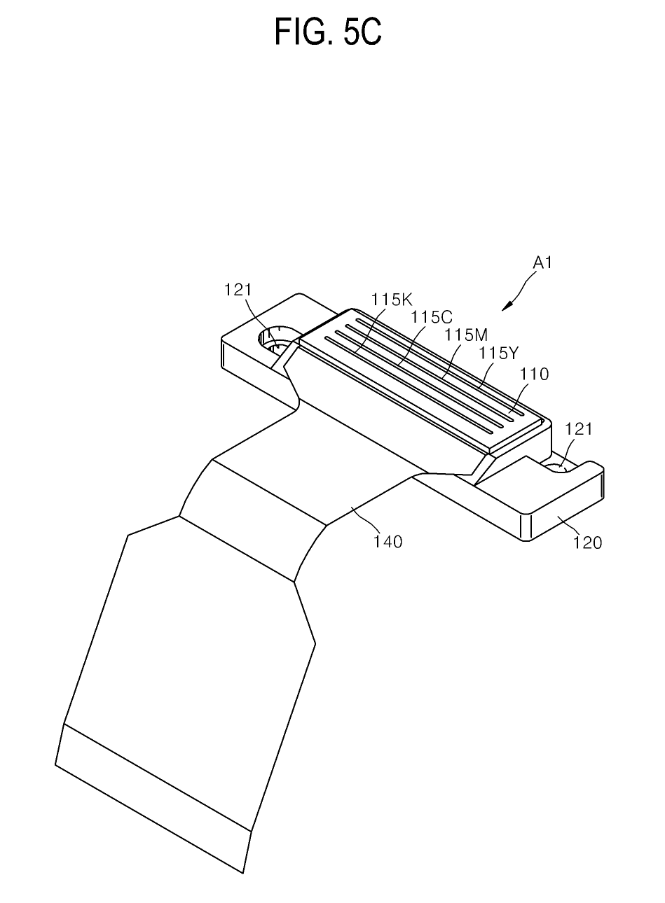

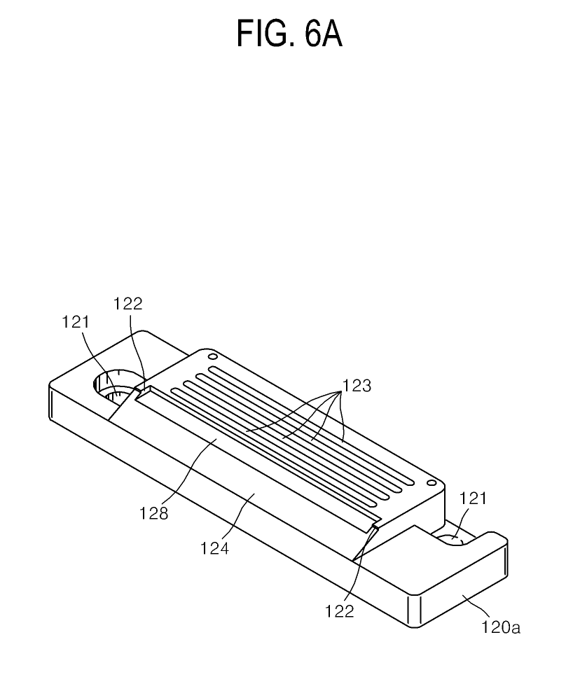

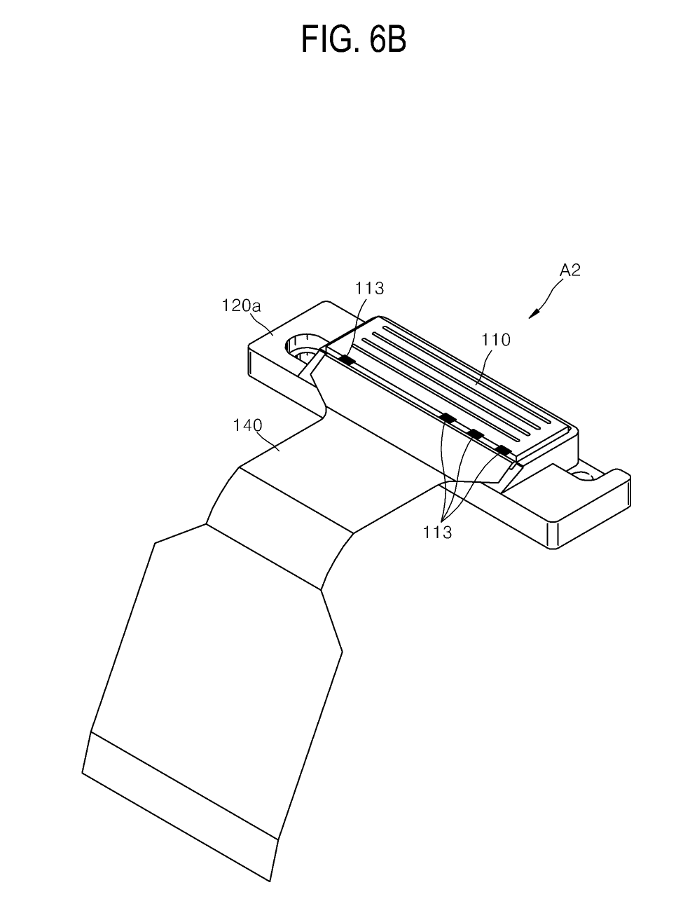

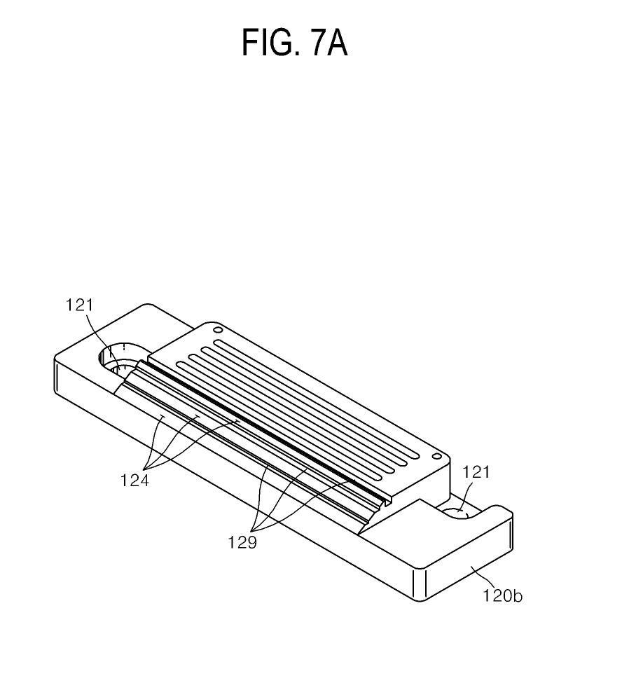

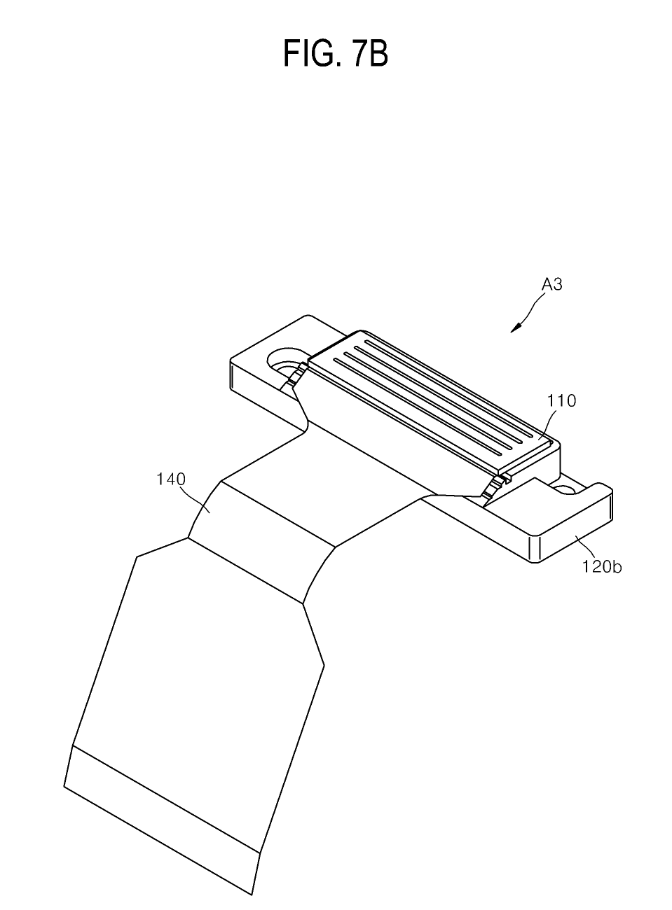

As illustrated in FIG. 4, the base plate 130 has a chip module receiving part 131 in which a chip module to be described (refer to A1 in FIG. 5C, A2 in FIG. 6B and A3 in FIG. 7B) is received.

Multiple chip module receiving parts 131 are arranged in an elongated direction of the base plate 130, where the elongated direction corresponds to the width direction J of the printing medium. As illustrated in FIG. 4, the chip module receiving part 131 may be arranged in two rows so that nozzles of head chips 110 can be superposed in the width direction of the printing medium. That is, a distance between adjacent chip module receiving parts 131 may be properly determined to obtain a predetermined distance H in FIG. 3 in the width direction J between adjacent head chips 110.

The chip module receiving part 131 has position determining protrusions 133 which are provided along a diagonal of the chip module receiving part 131 to determine an assembling position of a head chip supporting member 120 (to be described). Alternatively, the position determining protrusion 133 may be eliminated and the assembling position of the head chip supporting member 120 can be determined by a combining hole 121 of the head chip supporting member 120 and a supporting member combining hole 135 of the base plate 130. In this alternative, the position tolerances of the combining hole 121 and supporting member combining hole 135 are preferably made with more accuracy.

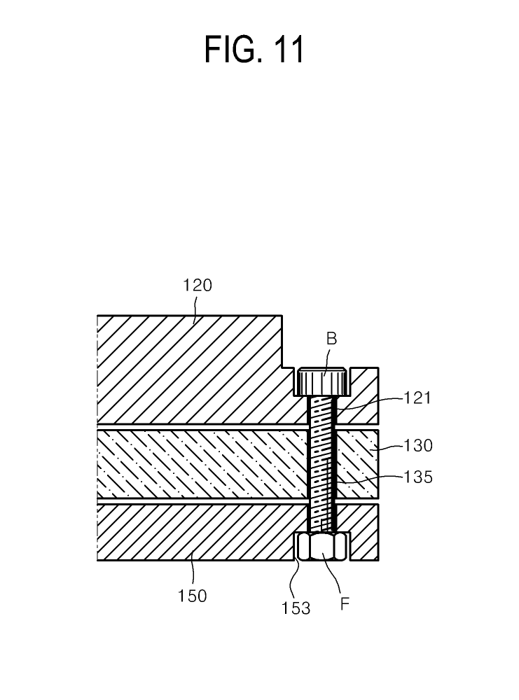

The supporting member combining hole 135 is provided to communicate with the combining hole 121 of the head chip supporting member 120. As illustrated in FIG. 11, a bolt B passes through the combining hole 121 and the supporting member combining hole 135 to be coupled with a nut F to be not rotated with respect to the intermediate plate 150. The intermediate plate 150 may have a nut receiving groove 153 to prevent the nut F from protruding. Alternatively, the nut F may be disposed in the base plate 130 instead of the intermediate plate 150, or altogether eliminated and replaced by forming a screw thread in the supporting member combining hole 135 as the occasion demands. Accordingly, the head chip supporting member 120 can be detachably combined with the base plate 130.

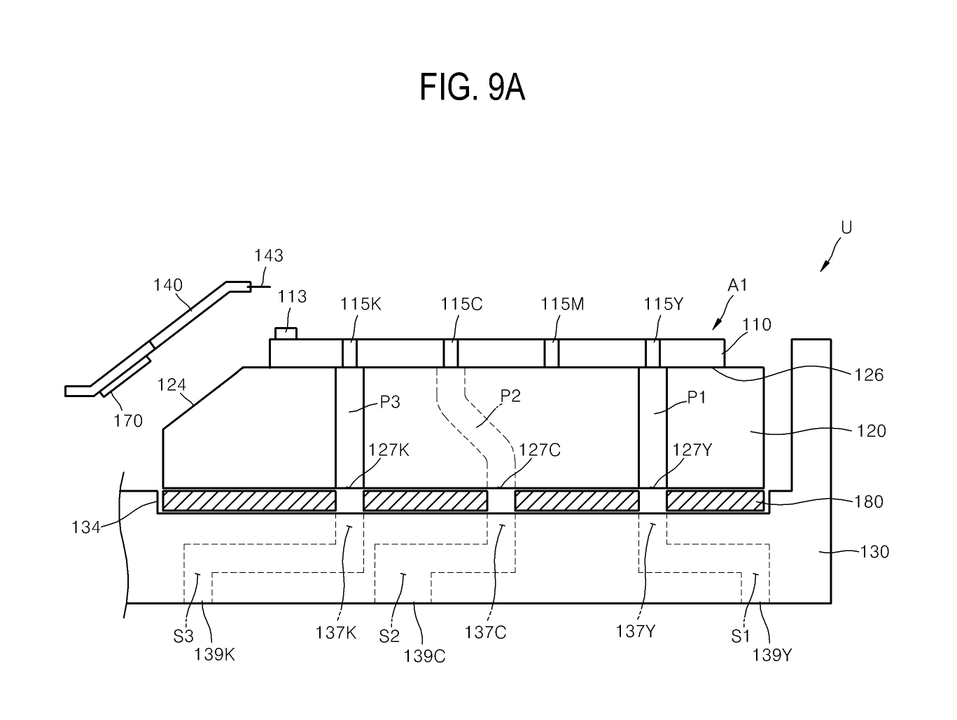

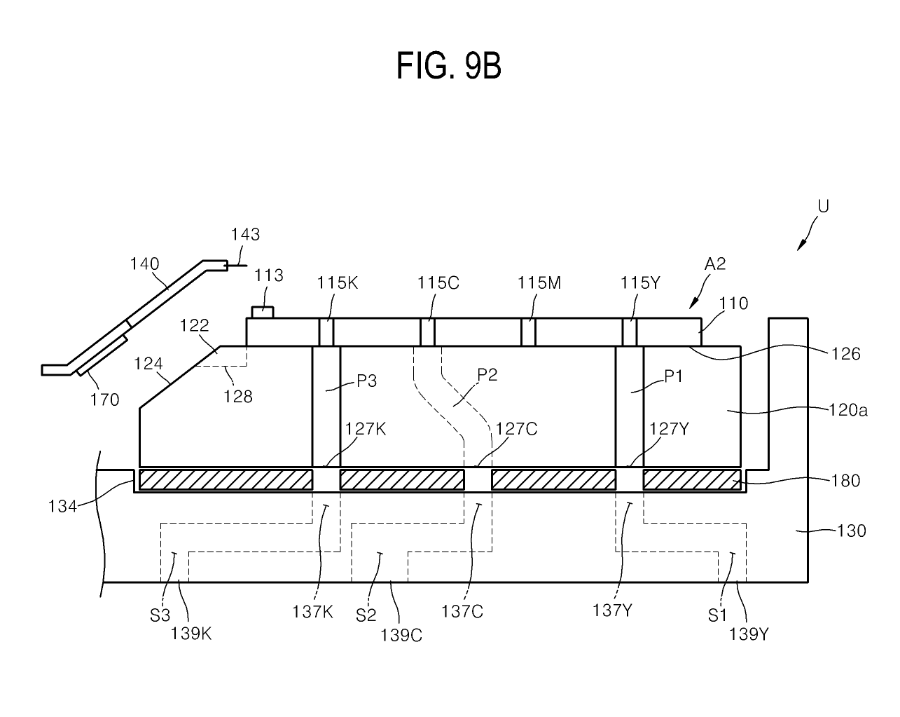

The chip module receiving part 131 may have a first ink outflow opening 137 to supply ink to the head chip supporting member 120. A first ink inflow opening 139 (refer to FIG. 9A) is formed to the opposite side of the first ink outflow opening 137, so that the ink having passed an ink flow path (not shown) in the intermediate plate 150 can flow in the first ink inflow opening 139. If an ink tank is provided for each of yellow (Y), magenta (M), cyan (C) and black (K) colors to perform color printing, the first ink outflow opening 137 and the first ink inflow opening 139 (refer to FIG. 9A) may be provided as four openings 137Y, 137M, 137C, 137K and 139Y, 139M, 139C, 139K (refer to FIG. 9A) respectively so that the ink of each color can flow in and out independently. Also, a first ink flow path S1, S2 S3, and S4 (S1, S2 and S3 illustrated in FIG. 9A) is formed to allow the first ink oufflow opening 137 communicate with the first ink inflow opening 139 (refer to FIG. 9A). If the ink colors are provided as the four Y, M, C and K colors, four first ink flow paths S1, S2, S3 and S4 (refer to FIG. 9A) are provided so that the inks of different colors can move independently. In FIG. 9A, the ink flow path S4 in which the ink of the magenta color passes through is not shown to avoid confusion due to superposition of the ink flow paths. Such first ink flow paths S1, S2, S3 and S4 (refer to FIG. 9A) may be provided with various patterns.

The base plate 130 may have a head position determining hole 138a which determines the assembling position of the base plate 130 within the inkjet printer 100. A position adjusting groove 138b is provided to the opposite side to the head position determining hole 138a to finely adjust a position of the base plate 130 after determining the coarse position with reference to the position determining hole 138a.

As illustrated in FIG. 9A, the chip module A1 includes the head chip 110, the head chip supporting member 120 and a flexible printed circuit 140.

The head chip 110, as illustrated in FIG. 9A, has an ink chamber (not shown), a nozzle (refer to 115Y, 115M, 115C and 115K) which is formed at a side of the ink chamber (not shown) toward the printing medium, and a heater (not shown) which is provided at the opposite side of the nozzle to heat the ink within the chamber. The head chip 110 having such a structure may be manufactured by a semiconductor process. Each of the nozzles 115Y, 115M, 115C and 115K discharges the ink of Y, M, C and K colors respectively. Also, as illustrated in FIG. 5C, the nozzles 115Y, 115M, 115C and 115K may be disposed along the width direction of the printing medium (refer to direction J in FIG. 3) to form nozzle lines.

The head chip 110 has a signal pad 113 to receive a heater driving signal from the controlling part (not shown) provided in the inkjet printer.

As illustrated in FIG. 5A, the head chip supporting member 120 has the combining hole 121, a second ink oufflow opening 123, an inclined surface 124 and a head chip receiving part 126.

The bolt (refer to B in FIG. 11) passes through the combining hole 121 so that the head chip supporting member 120 can be detachably combined to the base plate 130. As illustrated, two combining holes 121 may be provided along a line diagonal to the direction in which the sides of the head chip supporting member 120 extend. The two combining holes may have a receiving groove to prevent a head of the bolt from protruding. However, other combining structures known in the art besides the combining structure illustrated in the figures may also be used. Preferably such structures should detachably combine the head chip supporting member 120 to the base plate 130.

The second ink outflow opening 123 is formed at the head chip receiving part 126 to which the head chip 110 is combined. Also, the second ink outflow opening 123 is provided to communicate with each nozzle (refer to 115Y, 115M, 115C and 115K in FIG. 9A) of the head chip 110.

The inclined surface 124, as illustrated in FIG. 9A, is formed at an edge of a side part of the head chip supporting member 120, where the signal pad 113 of the head chip 110 is disposed, so that the flexible printed circuit 140 (to be described) can be bent along the inclined surface 124. However, the inclined surface 124 may be replaced with surfaces of different profiles, such as a curved surface, if desired, but the flat inclined surface 124 has been found to be preferable but not necessary with respect to workability.

FIG. 5B is a side view of the head chip supporting member 120.

As illustrated in FIG. 5B, the head chip supporting member 120 has a supporting member position determining hole 125a, a supporting member position adjusting groove 125b and a second ink inflow opening 127.

The supporting member position determining hole 125a and the supporting member position adjusting groove 125b receive the position determining protrusion 133 of the base plate 130 and hence position the head chip supporting member 120. Also, the supporting member position adjusting groove 125b is preferably an elongated groove so that the chip module A1 (accurately the head chip supporting member 120) can be aligned in the width direction of the printing medium (refer to J in FIG. 4). Therefore, alignment of the head chip 110 can be adjusted.

Each second ink inflow opening 127 is provided to communicate with a corresponding first ink outflow opening (refer to 137 in FIGS. 4 and 9A) of the base plate 130. For example, the first ink outflow opening (137Y in FIGS. 4 and 9A) through which a yellow ink flows out communicates with the second ink inflow opening 127Y through which the yellow ink flows in.

A gasket (refer to 180 in FIG. 9A) may be provided between the second ink inflow opening 127 and the first ink outflow opening 137 to prevent ink leakage. A gasket receiving groove (refer to 134 in FIGS. 4 and 9A) may be formed at the base plate 130 to receive the gasket.

As illustrated in FIG. 9A, second ink flow paths P1, P2, P3 and P4 may be formed to communicate the second ink inflow opening 127 with the second ink outflow opening 123. Patterns of the second ink flow paths P1, P2 and P3 may be different from those illustrated in FIG. 9A. Note that the inkflow path P4 corresponding to magenta is not shown in FIG. 9A to avoid confusion due to superposition of the ink flow paths.

The inkjet printer 100 according to this exemplary may further include the controlling part (not shown) to control the head chip 110.

According to the inkjet printer 100 described above, because the chip module A1 is detachably attached to the base plate 130 in a simple manner, a certain head chip 100 having a defect may be easily replaced, and hence manufacturing yield can be improved. Therefore, overall product manufacturing cost can be reduced.

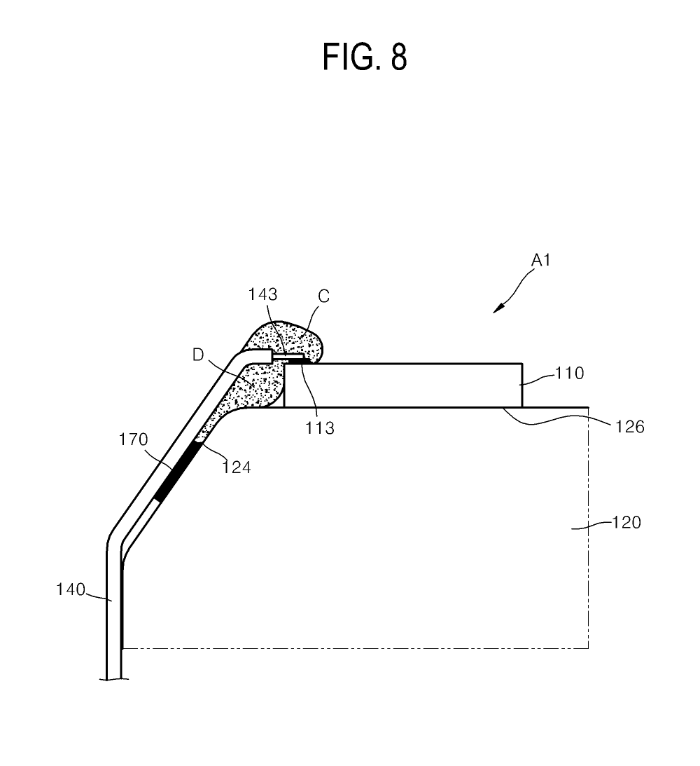

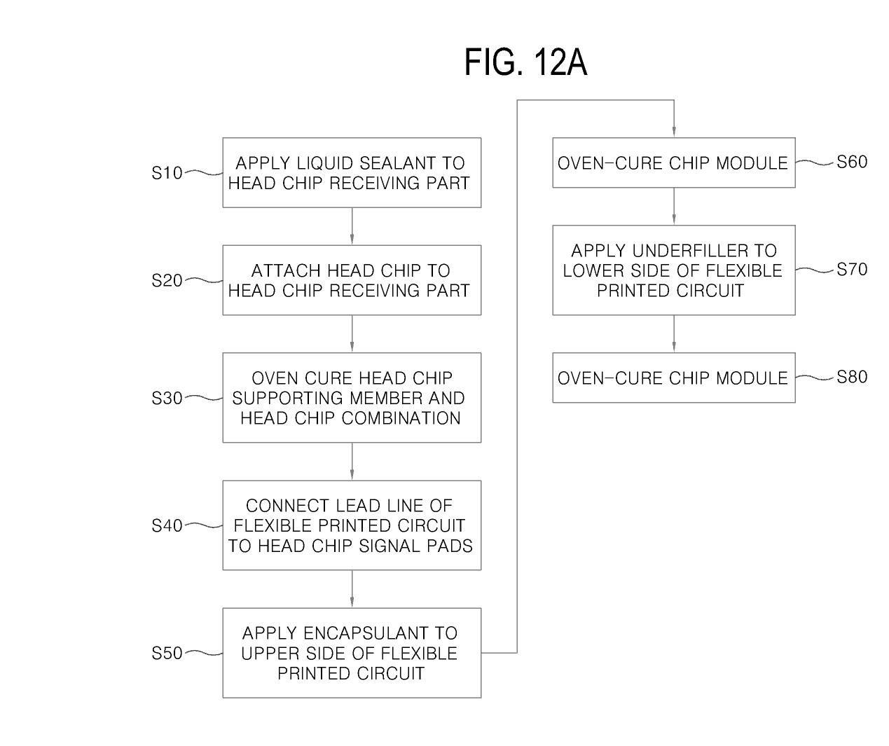

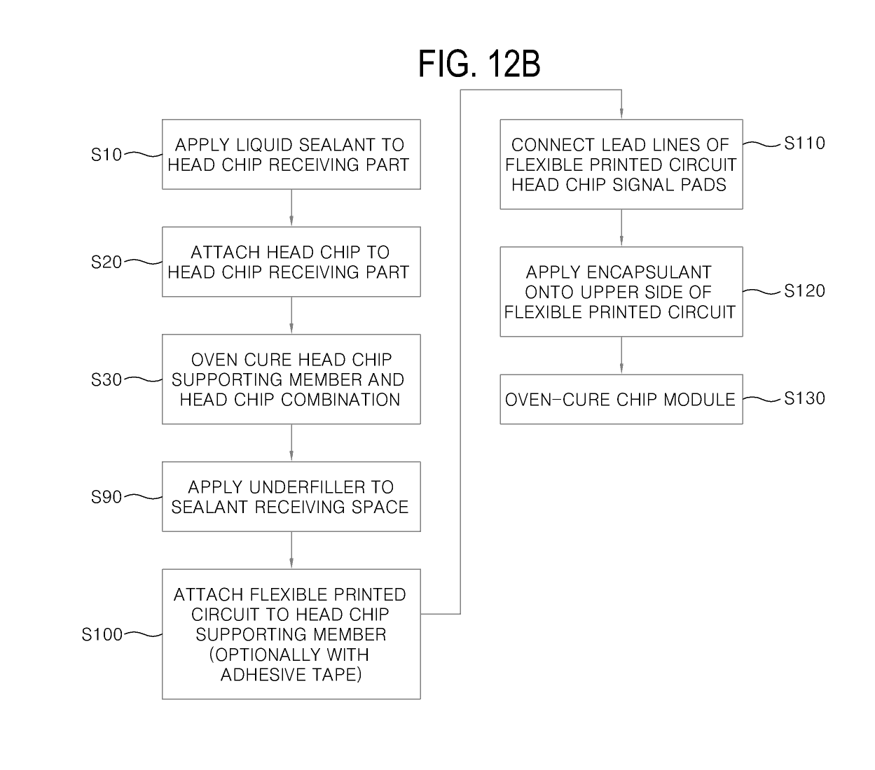

Hereinafter, an example of a manufacturing method of the chip module A1 is described with reference to FIG. 8 and FIG. 12A.

Firstly, a viscous liquid sealant is precisely applied onto the head chip receiving part 126 of the head chip supporting member 120 using a dispensing process so that the nozzles 115Y, 115M, 115C and 115K (refer to FIG. 5C) are not closed (operation S10).

Then, the head chip 110 is attached into the head chip receiving part 126 (operation S20). Alternatively, an adhesive film may be used in place of the sealant.

Head chip supporting member 120 attached with the head chip 110 is cured in oven so that the sealant or the adhesive film is hardened by heat (operation S30).

Then, a lead line 143 of the flexible printed circuit 140 is combined with the signal pad 113 of the head chip 110 using a bonding method such as tape automated bonding (TAB), chip on film (COF) bonding, welding and other known bonding techniques in the art (operation S40).

Then, a viscous liquid encapsulant C is applied onto an upper side of the flexible printed circuit 140 (operation S50). As the flexible printed circuit 140 is coupled with the head chip only through the contact between the lead line 143 and signal pad 113, their coupling is vulnerable. Therefore, the chip module A1 applied with the encapsulant C is oven-cured for hardening the encapsulant C in advance (operation S60).

Then, a liquid underfiller D is applied to a lower side of the flexible printed circuit 140 (operation S70). However, as the amount of the underfiller D flowing down the inclined surface 124 and settling between the flexible printed circuit 140 and with the inclined surface 124 is small, the attaching strength of the flexible printed circuit 140 onto the inclined surface 124 by the underfiller D is comparably weak. Therefore, it is preferable but not necessary that the flexible printed circuit 120 is attached to the inclined surface 124 with an adhesive tape 170 before the underfiller D is filled.

Then, the chip module A1 is oven-cured to harden the underfiller D (operation S80) and hence the chip module A1 is accomplished.

According to the manufacturing method described above, as the flexible printed circuit 140 can be closely attached to the inclined surface 140, the workability of later processes are improved. Also, as volume of the flexible printed circuit 140 is decreased, space efficiency is enhanced.

As illustrated in FIG. 6B, the inkjet printer according to another exemplary embodiment includes a chip module A2. As compared with the previous embodiment, elements other than the chip module A2 may be the same as those of the previous exemplary embodiment, and thus their descriptions are omitted.

The chip module A2 according to this exemplary embodiment includes a head chip 110, a head chip supporting member 120a and a flexible printed circuit 140.

As illustrated in FIG. 6A, the head chip supporting member 120a has a sealant receiving groove 128 and a blocking part 122 on an inclined surface 124.

As the chip module A2 is the same as the chip module (A1 in FIG. 5C) of the previous exemplary embodiment except that it further includes a sealant receiving groove 128 and a blocking part 122, the descriptions of the constituting elements same as those of the previous exemplary embodiment are omitted.

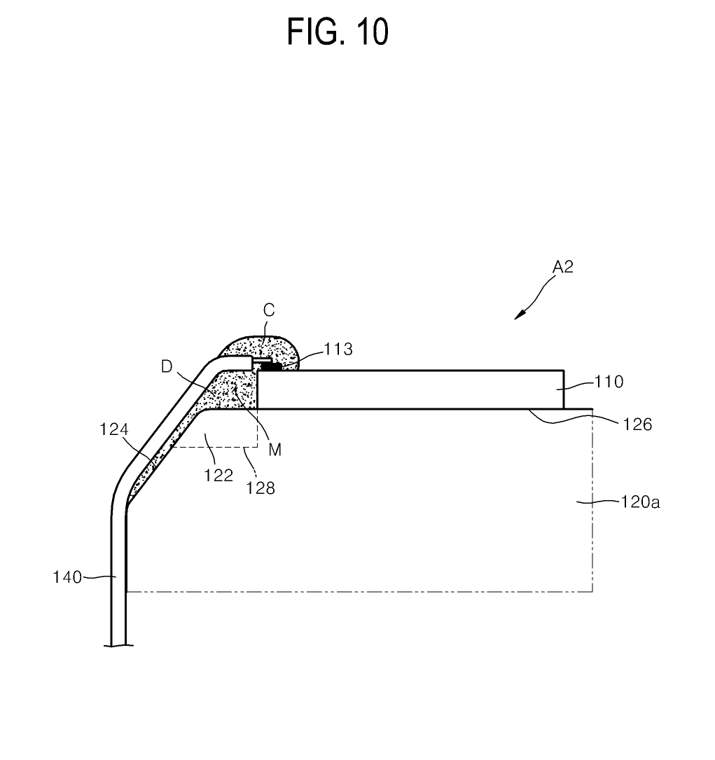

The sealant receiving groove 128 may extend along the length of the inclined surface 124. Here, the sealant receiving groove 128 extends along a direction in which the signal pads 113 of the head chip 110 are arranged. The sealant receiving groove 128 accepts some of underfiller D (refer to FIG. 10).

As illustrated in FIG. 9B, it is preferably but not necessary that the sealant receiving groove 128 is provided near to the signal pads 113 of the head chip 110. This location is preferable because the connection between the signal pads 113 of the head chip 110 and the lead lines 143 may have a weak coupling force and may easily lead to failure, such as a short-circuit due to humidity. Location of the sealant groove 128 near the signal pads 113 assist the underfiller D in providing an improved coupling of the FPC at the lead lines 143 and signal pads 113 to help avoid this problem. As illustrated in FIG. 6A, blocking part 122 protrudes from the inclined surface 124 at the lengthwise ends of the sealant receiving groove 128. Accordingly, some of the underfiller D (refer to FIG. 10) can be settled in a space defined by the blocking part 122 and the sealant receiving groove 128.

A manufacturing method of the above chip module A2 is described with reference to the examples illustrated in FIG. 9B, FIG. 10 and FIG. 12B.

The manufacturing method may be the same as that for making the chip module A1 of the previous exemplary embodiment in operations S10 to S30.

After the head chip 110 is attached to the head chip receiving part 126 through S10 to S30, the underfiller D is filled to a sealant receiving space M formed by the sealant receiving groove 128 and the blocking part 122 (operation S90). It is preferable but not necessary that the underfiller D has relatively high viscosity so that the amount of underfiller D staying in the sealant receiving space M is increased.

As illustrated in FIG. 9B, the flexible printed circuit 140 may be adhesively attached to the inclined surface 124 of the head chip supporting member 120a using an adhesive tape 170 already attached to the flexible printed circuit 140 (operation S100). However, as more underfiller D is filled in the sealant receiving space M as compared to that under the chip module A1 of the previous exemplary embodiment, an attaching strength of the flexible printed circuit 140 onto the inclined surface 124 is comparably high. Therefore, the operation S100 of the previous embodiment which attaching the flexible printed circuit 140 to the inclined surface 124 using the adhesive tape 170 may be excluded. FIG. 10 illustrates the chip module A2 where the adhesive tape 170 is not used.

Then, the lead line 143 of the flexible printed circuit 140 is combined with the signal pad 113 of the head chip 110 using a bonding method such as tape automated bonding (TAB), chip on film (COF) bonding, welding and other known techniques in the art (operation S110).

Then, a liquid encapsulant C is applied onto the upper side of the flexible printed circuit 140 (operation S120).

Then, the chip module A2 is oven-cured, so that the encapsulant C and the underfiller D are hardened at the same time (operation S130). In this case, it is preferable but not necessary that the encapsulant C and the underfiller D share the same oven-curing temperature so that the encapsulant C and the underfiller D may be hardened at the same temperature. This completes the manufacture of chip module A2 according to this embodiment.

The method of manufacturing the chip module A2 of this exemplary embodiment, heat curing the encapsulant C and the underfiller D at the same time differs from the chip module A1 of the previous exemplary embodiment which hardens the encapsulant C and the underfiller D by separate heating processes. The method of manufacturing the chip module A2 according this second exemplary embodiment thus can reduce thermal deformations of the head chip 110, the head chip supporting member 120 and the flexible printed circuit 140 due to thermal stress.

Also, as one step of oven-curing processes is eliminated, assembling performance can be improved and manufacturing cost can be reduced. Other examples according to the general inventive concept include manufacturing according to this embodiment modified to heat cure the encapsulant C and underfiller D according to the method of manufacture according to the previous embodiment, and similarly, and the manufacturing according to the previous embodiment modified to heat cure the encapsulant C and underfiller D according to the method of manufacture according to this embodiment.

Also, as the adhesive tape may not be used, the assembling performance can be improved and the manufacturing cost can be reduced.

As illustrated in FIG. 7B, the inkjet printer according to another exemplary embodiment includes a chip module A3. As compared to the previous exemplary embodiment, elements other than the chip module A3 may be the same as those of previous exemplary embodiment, and their descriptions and illustrations are omitted.

The chip module A3 according to this exemplary embodiment includes a head chip 110, a head chip supporting member 120b and a flexible printed circuit 140.

As illustrated in FIG. 7A, the head chip supporting member 120b has a plurality of sealant receiving grooves 129 formed on an inclined surface 124.

The sealant receiving grooves 129 may be provided as notches indented into the inclined surface 124. However, the shape of the sealant receiving grooves 129 is not limited to notches but may include other types of depressions in the inclined surface 124 to enable the underfiller D (refer to FIG. 10) to settle.

In addition, although each of the sealant receiving grooves 129 extend across the whole of the inclined surface 124 in its lengthwise direction (and hence there is no element corresponding to the blocking part 122 of the previous exemplary embodiment), an element corresponding to the blocking part 122 of the previous exemplary embodiment may be added if desired. Whether or not to use the blocking part 122 may depend on whether or not the width of the sealant receiving groove 129 is narrow enough and the viscosity of the underfiller D is sufficient for the underfiller D (refer to FIG. 10) to settle and remain during assembly.

As the manufacturing method of the chip module A3 according to the present exemplary embodiment may be the same as that of the chip module according to any of the examples described above, its description is omitted.

Certain features of the inkjet printers and the inkjet printer head-chip assemblies according to the examples described above are set forth below.

First, product yield is increased.

Second, as the head chip may be detachably attached to the base plate, the assembling performance and the productivity can be improved.

Third, as a wire bonding that connects the lead line of the flexible printed circuit to the head chip may be conducted when creating a chip module instead of when the head chip is combined with the base plate, the workability of the wiring operation is improved.

Fourth, as any defective head chip may be easily substituted with a new one during product manufacturing process, the manufacturing cost can be lowered.

Fifth, if a defect occurs in a certain head chip while a user using the inkjet printer after its production completed, after service (AS) repair can be easily conducted and hence customer satisfaction can be improved.

Sixth, as one of the oven-curing processes may be eliminated during the chip module manufacturing, the thermal deformation of the chip module due to thermal stress can be reduced.

Although a few exemplary embodiments of the present general inventive concept have been illustrated and described, it will be appreciated by those skilled in the art that changes may be made in these embodiments without departing from the principles and spirit of the general inventive concept, the scope of which is defined in the appended claims and their equivalents. As used in this disclosure, the term “preferably” is non-exclusive and means “preferably, but not limited to.” Terms in the claims should be given their broadest interpretation consistent with the general inventive concept as set forth in this description. For example, the terms “coupled” and “connect” (and derivations thereof) are used to connote both direct and indirect connections/couplings. As another example, “having” and “including”, derivatives thereof and similar transition terms or phrases are used synonymously with “comprising” (i.e., all are considered “open ended” terms)—only the phrases “consisting of” and “consisting essentially of” should be considered as “close ended”. Claims are not intended to be interpreted under 112 sixth paragraph unless the phrase “means for” and an associated function appear in a claim and the claim fails to recite sufficient structure to perform such function.

What is claimed is:

1. An inkjet printer comprising:
an ink tank;
a head chip comprising a nozzle and a signal pad;
a base plate provided between the ink tank and the head chip and having a first ink flow path through which ink of the ink tank is supplied to the head chip;
a head chip supporting member provided between the base plate and the head chip, comprising a second ink flow path to allow the nozzle to communicate with the first ink flow path, and detachably connected to the base plate together with the head chip.

2. The inkjet printer according to claim 1, further comprising a plurality of head chips, a plurality of corresponding head chip supporting members, and a plurality of corresponding first and second ink flow paths to supply the ink of the ink tank to each head chip.

3. The inkjet printer according to claim 1, further comprising:
a controller to control the head chip.

4. The inkjet printer according to claim 3, further comprising a flexible printed circuit which connects the signal pad of the head chip with the controller to transmit a control signal of the controller to the head chip, wherein an edge of the head chip supporting member adjacent to the signal pad is a surface-processed edge and the flexible printed circuit is bent to be attached to the edge.

5. The inkjet printer according to claim 4, wherein the surface-processed edge of the head chip supporting member is an inclined surface.

6. The inkjet printer according to claim 4, wherein the surface-processed edge of the head chip supporting member is a curved surface.

7. The inkjet printer according to claim 4, wherein the head chip supporting member has a sealant receiving groove which is formed within the surface-processed edge.

8. The inkjet printer according to claim 7, wherein the head chip supporting member has a plurality of sealant receiving grooves within the surface-processed edge.

9. The inkjet printer according to claim 7, wherein the head chip supporting member further comprises blocking parts which are provided at opposite ends of the sealant receiving groove to reduce leakage of a sealant from the sealant receiving groove.

10. The inkjet printer according to claim 1, wherein the head chip supporting member and the base plate are connected together with a separable connection element.

11. An inkjet printer head-chip assembly comprising:
a base plate comprising a first ink inflow opening, a first ink outflow opening, and a first ink flow path which allows the first ink inflow opening to communicate with the first ink outflow opening;
a head chip comprising a nozzle and a signal pad which receives a signal; and
a head chip supporting member comprising a head chip receiving part to which the head chip is combined, a second ink inflow opening which communicates with the first ink outflow opening, a second ink outflow opening which is provided at the head chip receiving part to communicate with the nozzle, and a second ink flow path which allows the second ink inflow opening to communicate with the second ink outflow opening, wherein the head chip is attached to the head chip supporting member and the head chip supporting member is detachably coupled with the base plate together with the attached head chip.

12. The inkjet printer head-chip assembly according to claim 11, further comprising:
a same plural number of the head chips and corresponding head chip supporting members, and the base plate further comprises the same plural number of chip module receiving parts to which a corresponding head chip supporting member is received, the plural number of chip module receiving parts arranged to extend in a lengthwise direction of the base plate.

13. The inkjet printer head-chip assembly according to claim 11, further comprising:
a flexible printed circuit which is connected to the signal pad of the head chip to transmit a signal to the head chip, wherein an edge of the head chip supporting member adjacent to the signal pad is a surface-processed edge and the flexible printed circuit is bent to be attached to the edge.

14. The inkjet printer head-chip assembly according to claim 13, wherein the surface-processed edge of the head chip supporting member is an inclined surface.

15. The inkjet printer head-chip assembly according to claim 13, wherein the surface-processed edge of the head chip supporting member is a curved surface.

16. The inkjet printer head-chip assembly according to claim 13, wherein the head chip supporting member has a sealant receiving groove formed within the surface-processed edge.

17. The inkjet printer head-chip assembly according to claim 16, wherein the head chip supporting member includes a plurality of sealant receiving grooves within the surface-processed edge.

18. The inkjet printer head-chip assembly according to claim 17, further comprising:
a blocking part which is provided at each end of the sealant receiving groove to reduce leakage of a sealant therefrom.

19. The inkjet printer head-chip assembly according to claim 11, wherein the head chip supporting member and the base plate are connected together by a separable connection element.

20. A method of manufacturing an image forming apparatus, comprising:
attaching a plurality flexible printed circuits to corresponding head chips mounted on corresponding head chip supporting members; and
after the attaching the plurality of flexible printed circuits to corresponding head chips, detachably mounting the plurality of head chip supporting members to a base plate.

21. The method of claim 20, wherein the operation of mounting includes mounting the plurality of head chip supporting members to extend along a lengthwise direction of the base plate.

22. The method of claim 21, wherein the operation of mounting includes mounting the plurality of head chip supporting members in at least two rows, each of the two rows extending in the lengthwise direction of the base plate.

23. A method of assembling an image forming apparatus, comprising:
attaching each of a plurality of head chips to a corresponding head chip supporting member; and
detachably mounting the plurality of head chip supporting members to a base plate.

24. The method of claim 23, wherein the operation of detachably mounting includes detachably mounting the plurality of head chip supporting members with screws.

25. The method of claim 23, wherein the operation of detachably mounting the plurality of head chip supporting members to the base plate includes fitting a protrusion of the base plate within an alignment hole or depression within a head chip supporting member.

26. The method of claim 23, further comprising:
determining at lest one of the head chips fixed to a corresponding head chip supporting member is defective; and
detaching and replacing the defective head chip and corresponding head chip supporting member.

27. A method of assembling an image forming apparatus, comprising:
attaching a head chip to a corresponding head chip mounting member;
attaching a flexible printed circuit to the head chip, including wire bonding leads to signal pads of the head chip;
at least partially encapsulating the leads; and
mounting the head chip mounting member with attached corresponding head chip to a base plate.

28. The method of claim 27, wherein the operation of at least partially encapsulating the leads includes for each combination of a head chip mounting member, a head chip and a flexible printed circuit:
first, providing an encapsulant about the leads;
second, heat treating the encapsulant to harden the encapsulant;
third, providing an underfill between the flexible printed circuit and the head chip mounting member; and
fourth, heat treating the underfill to harden the underfill.

29. The method of claim 27, wherein the operation of at least partially encapsulating the leads includes for combination of a head chip mounting member, a head chip and a flexible printed circuit:
first, providing a deformable encapsulant about the leads and a deformable underfill interposed between the flexible printed circuit and the head chip mounting member;
second, heat treating the deformable encapsulant and deformable underfill to harden the encapsulant and underfill.

30. The method of claim 28, wherein the operation of providing an underfill includes providing an underfill within at least one groove formed within a side surface of the head chip mounting member.
